(19) United States
(12) Patent Application Publication
(10) Pub. No.: US 2025/0250172 A1
(43) Pub. Date: Aug. 7, 2025

(54) HARD CARBON MATERIAL, NEGATIVE ELECTRODE PLATE, SECONDARY BATTERY, AND ELECTRIC APPARATUS

(71) Applicant: Ningde Amperex Technology Limited, Ningde (CN)

(72) Inventors: Zigui ZHENG, Ningde (CN); Zheng YI, Ningde (CN); Wenlong SHAO, Ningde (CN); Yuansen XIE, Ningde (CN)

(73) Assignee: Ningde Amperex Technology Limited, Ningde (CN)

(21) Appl. No.: 19/046,832

(22) Filed: Feb. 6, 2025

(30) Foreign Application Priority Data
Feb. 6, 2024 (CN) 202410169867.3

(51) Int. Cl. C01B 32/05

(52) U.S. Cl. CPC C01B 32/05; C01P 2002/72; C01P 2004/51; C01P 2004/61; C01P 2006/10; C01P 2006/12; C01P 2006/14; C01P 2006/40

(57) ABSTRACT

A hard carbon material, having a first characteristic peak from 15° to 35° and a second characteristic peak from 25° to 28° in an X-ray diffraction pattern of the hard carbon material. A starting position of the first characteristic peak is A°, an ending position of the first characteristic peak is B°, and B−A≥8°. A peak intensity of the first characteristic peak is I1, a peak intensity of the second characteristic peak is I2, and 0.1≤I2/I1≤3.0. When a negative electrode plate prepared using the hard carbon material as an active material is subjected to charge and discharge test with lithium metal as a counter electrode to obtain a differential capacity curve, the negative electrode plate has four reversible lithium intercalation peaks and three or four reversible lithium deintercalation peaks within a voltage range of 0 V to 0.4 V.

### CROSS-REFERENCE TO RELATED APPLICATION

This application claims priority from Chinese Patent Application No. 202410169867.3, filed on Feb. 6, 2024, the content of which is incorporated herein by reference in its entirety.

### TECHNICAL FIELD

This application relates to the field of electrochemical technologies, and in particular, to a hard carbon material, a negative electrode plate, a secondary battery, and an electric apparatus.

### BACKGROUND

Secondary batteries represented by lithium-ion batteries have outstanding characteristics such as high energy density, long cycle life, low pollution, and no memory effect. As a clean energy source, the application of secondary batteries has gradually expanded from electronic products to large devices such as electric vehicles, to meet the sustainable development strategies for the environment and energy. Thus, higher requirements are imposed on the energy density of secondary batteries.

Currently, commercial secondary battery negative electrode active materials still mainly include graphite. Graphite has the advantages such as high conductivity and high stability. However, the theoretical capacity of graphite is approximately 372 mAh/g, and in recent years, it has almost been developed to the upper limit. Thus, it is less likely to further increase the energy density of lithium-ion batteries with graphite as their negative electrode active materials.

### SUMMARY

This application is intended to provide a hard carbon material, a negative electrode plate, a secondary battery, and an electric apparatus so as to improve the energy density and cycling performance of the secondary battery. Specific technical solutions are described below.

It should be noted that in the summary of this application, examples in which lithium-ion batteries and sodium-ion batteries are used as secondary batteries are used to illustrate this application. However, the secondary battery in this application is not limited to the lithium-ion battery and the sodium-ion battery.

According to a first aspect of this application, a hard carbon material is provided. An X-ray diffraction pattern of the hard carbon material has a first characteristic peak from 150 to 350 and a second characteristic peak from 25° to 28°. A starting position of the first characteristic peak is A°, an ending position of the first characteristic peak is B°, and B−A≥8°. A peak intensity of the first characteristic peak is I1, a peak intensity of the second characteristic peak is 12, and 0.1≤I2/I1≤3.0. The hard carbon material is used as a negative electrode active material to prepare a negative electrode plate, where the negative electrode plate is subjected to charge and discharge test with lithium metal as a counter electrode to obtain a differential capacity curve, and the negative electrode plate has four reversible lithium intercalation peaks and three or four reversible lithium deintercalation peaks within a voltage range of 0 V to 0.4 V. The X-ray diffraction pattern of the hard carbon material in this application has the first characteristic peak and the second characteristic peak. In addition, four reversible lithium intercalation peaks and three or four reversible lithium deintercalation peaks are present within the voltage range of 0 V to 0.4 V in the dQ/dV curve. Further, controlling the values of B−A and I2/I1 within the above ranges indicates that the hard carbon material in this application has a locally ordered graphitization structure inside. Since the locally ordered graphitization structure is introduced into the hard carbon material, as compared with a completely disordered hard carbon material, the hard carbon material has a high reversible capacity and an increased true density. When the hard carbon material is used in a secondary battery, the energy density of the secondary battery can be increased. In addition, the locally ordered graphitization structure can shorten a lithium ion transport path in the hard carbon material, which is conducive to improving the kinetic performance of the secondary battery, thereby improving the cycling performance of the secondary battery.

In an embodiment of this application, the hard carbon material has an internal pore structure, and a maximum inscribed circle diameter of pores in the internal pore structure is 0.40 nm to 10 nm, preferably 0.40 nm to 2 nm, and further preferably 0.40 nm to 0.80 nm. When the hard carbon material has the internal pore structure, the hard carbon material has a high reversible capacity. Controlling the maximum inscribed circle diameter of the pores in the internal pore structure of the hard carbon material within the above ranges is conducive to increasing the reversible capacity of the hard carbon material, especially a low voltage plateau capacity. The hard carbon material being used in the secondary battery is conducive to improving the energy density and first-cycle coulombic efficiency of the secondary battery, and improving the cycling performance of the secondary battery.

In an embodiment of this application, a surface of the hard carbon material has an external pore structure, and a pore volume of the external pore structure obtained by adsorption test is less than or equal to 0.05 cc/g. The pore volume of the external pore structure of the hard carbon material obtained by adsorption test is within the above range, indicating that the external pore volume of the hard carbon material in this application is small, which is conducive to improving the lithium storage performance of the hard carbon material. The hard carbon material being used in the secondary battery is conducive to improving the energy density and first-cycle coulombic efficiency of the secondary battery, and improving the cycling performance of the secondary battery.

In an embodiment of this application, a true density of the hard carbon material is 0.9 g/cc to 2.0 g/cc. Controlling the true density of the hard carbon material within the above range allows the hard carbon material to have a lot of internal pore structures inside, facilitating storage of lithium ions or sodium ions. The hard carbon material being used in the secondary battery is conducive to improving the energy density and first-cycle coulombic efficiency of the secondary battery, and improving the cycling performance of the secondary battery.

In an embodiment of this application, a specific surface area of the hard carbon material is 0.5 m²/g to 50 m²/g, preferably 0.5 m²/g to 5 m²/g. Controlling the specific surface area of the hard carbon material within the above range is conducive to forming a SEI film with a moderate area during the first charge process when the hard carbon material is used in the secondary battery. This reduces the amount of a negative electrode binder in a negative electrode active material layer, thereby reducing the loss of active ions, and reducing the internal resistance of the negative electrode active material layer. Thus, this improves the energy density and first-cycle coulombic efficiency of the secondary battery, and improves the cycling performance and safety performance of the secondary battery.

In an embodiment of this application, Dᵥ50 of the hard carbon material is 3 μm to 12 μm, preferably 5 μm to 9 μm. Controlling Dᵥ50 of the hard carbon material within the above range allows hard carbon material particles to have good electrolyte infiltration performance and a small specific surface area, thereby reducing active ions consumed by the formation of the SEI film on the surface of the hard carbon material particles during the first charge process. The hard carbon material being used in the secondary battery is conducive to improving the energy density and first-cycle coulombic efficiency of the secondary battery, and improving the cycling performance of the secondary battery.

In an embodiment of this application, the hard carbon material includes a heteroelement, where the heteroelement includes at least one of Li, Na, K, Cs, Mg, Al, Ca, Rb, Zn, Fe, Ni, Co, N, O, H, P, S, B, or Se, and based on a mass of the hard carbon material, a mass percentage of the heteroelement is greater than 0 and less than or equal to 3%. Controlling the mass percentage of the heteroelement within the above range is conducive to the local graphitization of the hard carbon material, improving the stability of the hard carbon material during an electrochemical reaction process, and allowing the hard carbon material to have a high specific capacity and first-cycle coulombic efficiency. The hard carbon material being used in the secondary battery is conducive to improving the energy density and first-cycle coulombic efficiency of the secondary battery, and improving the cycling performance of the secondary battery.

According to a second aspect of this application, a preparation method of a hard carbon material is provided, including the following steps:
(1) well mixing a reactant, a catalyst, and a solvent to obtain a reaction solution, and drying the reaction solution to obtain a precursor; where a mass ratio of the catalyst to the reactant is 0.01 to 1; the reactant includes at least one of novolac resin, furfural resin, epoxy resin, asphalt, starch, glucose, sucrose, or fructose; the solvent includes at least one of ionized water, ethanol, benzene, toluene, or N-methylpyrrolidone; and the catalyst includes at least one of lithium hydroxide, sodium hydroxide, potassium hydroxide, magnesium hydroxide, cesium hydroxide, rubidium hydroxide, calcium hydroxide, aluminum hydroxide, alumina, aluminum oxide, zinc oxide, zinc chloride, iron, triiron tetraoxide, ferric chloride, ferric oxide, nickel oxide, nickel sulfate, nickel hydroxide, nickel chloride, cobalt nitrate, cobalt oxide, urea, phosphoric acid, lignin, boric acid, sodium selenate, sodium benzoate, potassium benzoate, or sodium cinnamate;
(2) performing acid washing after a first carbonization treatment on the precursor in an inert atmosphere, and then performing a second carbonization treatment in the inert atmosphere to obtain a carbonization product; where a temperature T1 of the first carbonization treatment is 500° C. to 900° C., a time t1 of the first carbonization treatment is 0.5 h to 5 h, and a heating velocity v1 of the first carbonization treatment is 0.5° C./min to 10° C./min; and a temperature T2 of the second carbonization treatment is 1000° C. to 1600° C., a time t2 of the second carbonization treatment is 0.5 h to 15 h, and a heating velocity v2 of the second carbonization treatment is 0.5° C./min to 10° C./min; and
(3) heating the carbonization product to 500° C. to 1100° C. in the inert atmosphere at a heating velocity of 0.5° C./min to 20° C./min, and then performing a heat preservation treatment in a reducing atmosphere to obtain a hard carbon material; where the inert atmosphere includes at least one of a nitrogen gas, an argon gas, or a helium gas; a time t3 of the heat preservation treatment is 0.1 h to 8 h; and the reducing atmosphere includes at least one of the argon gas, acetylene, or methane.

The method provided in the second aspect of this application is used for preparing a hard carbon material, and various parameters are controlled within the above range, so that the obtained hard carbon material has a high specific capacity and first-cycle coulombic efficiency. When the obtained hard carbon material is used in a negative electrode plate of a secondary battery, the energy density of the secondary battery can be increased, and the cycling performance of the secondary battery can be improved.

According to a third aspect of this application, a negative electrode plate is provided. The negative electrode plate includes a negative electrode current collector and a negative electrode active material layer disposed on at least one surface of the negative electrode current collector. The negative electrode active material layer includes the hard carbon material provided in the first aspect of this application or a hard carbon material prepared using the preparation method provided in the second aspect of this application. The negative electrode plate provided in the third aspect of this application has a high reversible capacity and good kinetic performance. When the negative electrode plate is used in a secondary battery, the energy density and first-cycle coulombic efficiency of the secondary battery can be improved, and the cycling performance of the secondary battery can be improved.

In an embodiment of this application, a compacted density of the negative electrode active material layer is 0.7 g/cm³ to 1.7 g/cm³. A low compacted density of the negative electrode active material layer indicates that a lot of internal pore structures are present in the negative electrode active material layer, facilitating the infiltration of an electrolyte into negative electrode active material particles, thereby improving the cycling kinetic performance of the secondary battery. Controlling the compacted density of the negative electrode active material layer within the above range is conducive to increasing the volumetric energy density of the secondary battery. Therefore, the secondary battery has a high energy density and good cycling performance.

In an embodiment of this application, a porosity of the negative electrode active material layer is 10% to 50%. Controlling the porosity of the negative electrode active material layer within the above range facilitates the infiltration of the electrolyte into the negative electrode active material particles, thereby improving the cycling kinetic performance of the secondary battery, allowing contact points between the negative electrode active material particles to be within an appropriate range, balancing the internal resistance of the secondary battery, and increasing the volumetric energy density of the secondary battery.

According to a fourth aspect of this application, a secondary battery is provided, including the negative electrode plate according to any one of the foregoing embodiments. The secondary battery provided in the fourth aspect of this application has a high energy density and first-cycle coulombic efficiency as well as good cycling performance.

According to a fifth aspect of this application, an electric apparatus is provided, including the secondary battery according to any one of the foregoing embodiments. The electric apparatus in this application has a long service life.

The beneficial effects of this application are described below.

This application provides a hard carbon material. An X-ray diffraction pattern of the hard carbon material has a first characteristic peak from 15° to 350 and a second characteristic peak from 25° to 28°. A starting position of the first characteristic peak is A°, an ending position of the first characteristic peak is B°, and B−A≥8°. A peak intensity of the first characteristic peak is I1, a peak intensity of the second characteristic peak is 12, and 0.1≤I2/I1≤3.0. The hard carbon material is used as a negative electrode active material to prepare a negative electrode plate, where the negative electrode plate is subjected to charge and discharge test with lithium metal as a counter electrode to obtain a differential capacity curve, and the negative electrode plate has four reversible lithium intercalation peaks and three or four reversible lithium deintercalation peaks within a voltage range of 0 V to 0.4 V. The X-ray diffraction pattern of the hard carbon material in this application has the first characteristic peak and the second characteristic peak. In addition, four reversible lithium intercalation peaks and three or four reversible lithium deintercalation peaks are present within the voltage range of 0 V to 0.4 V in the dQ/dV curve. Further, controlling the values of B−A and I2/I1 within the above ranges indicates that the hard carbon material in this application has a locally ordered graphitization structure inside. Since the locally ordered graphitization structure is introduced into the hard carbon material, as compared with a completely disordered hard carbon material, the hard carbon material has a high reversible capacity and an increased true density, thereby increasing the energy density of a secondary battery. In addition, the locally ordered graphitization structure can shorten diffusion paths of lithium ions inside the hard carbon material, thereby improving the kinetic performance of the secondary battery. Therefore, the secondary battery has a high energy density and good cycling performance.

Certainly, when any product or method of this application is implemented, all advantages described above are not necessarily achieved simultaneously.

### BRIEF DESCRIPTION OF DRAWINGS

To describe the technical solutions in some embodiments of this application or the prior art more clearly, the following briefly describes the accompanying drawings required for describing some embodiments or the prior art. Apparently, the accompanying drawings in the following description show merely some embodiments of this application, and persons of ordinary skill in the art may still derive other drawings from these accompanying drawings.

FIG. 1 is an X-ray diffraction pattern of Example 4 of this application;

FIG. 2 is an X-ray diffraction peak separation pattern after baseline correction of FIG. 1; and

FIG. 3 is a differential capacity curve of Example 4 of this application.

### DETAILED DESCRIPTION

The following clearly and completely describes the technical solutions in some embodiments of this application with reference to the accompanying drawings in some embodiments of this application. Apparently, the described embodiments are only some rather than all embodiments of this application. All other embodiments obtained by persons skilled in the art based on this application fall within the protection scope of this application.

It should be noted that in the summary of this application, examples in which lithium-ion batteries and sodium-ion batteries are used as secondary batteries are used to illustrate this application. However, the secondary battery in this application is not limited to the lithium-ion battery.

At present, among a lot of negative electrode active materials to be developed, a hard carbon material has attracted much attention due to its advantages such as high gram capacity and good rate performance, low-temperature performance, and cycling performance. In addition, the hard carbon material can be used as a negative electrode active material of the lithium-ion battery and can also be used in the sodium-ion battery, with great application prospects. However, the hard carbon material in the prior art have problems such as high irreversible capacity, high average lithium deintercalation potential, and low density. When the hard carbon material is used in the secondary battery, the improvement in the energy density of the secondary battery is limited, making it difficult to meet the needs of practical application. Based on this, this application provides a hard carbon material, a secondary battery, and an electric apparatus. The hard carbon material has high first-cycle coulombic efficiency and high reversible capacity. When the hard carbon material is used in the secondary battery, the energy density and cycling performance of the secondary battery can be improved.

According to a first aspect of this application, a hard carbon material is provided. An X-ray diffraction pattern of the hard carbon material has a first characteristic peak from 150 to 350 and a second characteristic peak from 25° to 28°. A starting position of the first characteristic peak is A°, an ending position of the first characteristic peak is B°, and B−A≥8°. For example, the value of B−A may be 8°, 9°, 10°, 11°, 12°, 13°, 14°, 15°, 16°, 17°, 18°, 19°, or 20°, or falls within a range defined by any two of these values. A peak intensity of the first characteristic peak is I1, a peak intensity of the second characteristic peak is 12, and 0.1≤I2/I1≤3.0. For example, the value of I2/I1 may be 0.1, 0.3, 0.5, 0.7, 1.0, 1.3, 1.5, 1.7, 2.0, 2.2, 2.5, 2.7, or 3.0, or falls within a range defined by any two of these values. The hard carbon material is used as a negative electrode active material to prepare a negative electrode plate, where the negative electrode plate is subjected to charge and discharge test with lithium metal as a counter electrode to obtain a differential capacity (dQ/dV) curve, and the negative electrode plate has four reversible lithium intercalation peaks and three or four reversible lithium deintercalation peaks within a voltage range of 0 V to 0.4 V.

The inventors have found that during a preparation process of a hard carbon material, percentages of heteroatoms such as H, O, and N in a precursor are high. During a low-temperature pyrolysis process, the heteroatoms form a large number of cross-linked structures, thereby hindering the formation of crystallization regions. As a result, the hard carbon material is less likely to graphitize even at a temperature of 2500° C. or above. After high-temperature carbonization, the hard carbon material has curved graphite microcrystals arranged in a short-range order, 2 to 6 layers are formed without stacking, and a highly distorted structure is formed. This significantly reduces a true density of the hard carbon material. An X-ray diffraction pattern of a completely disordered hard carbon material has only a first characteristic peak and no second characteristic peak. The completely disordered hard carbon material is used as a negative electrode active material to prepare a negative electrode plate. The negative electrode plate is subjected to charge and discharge test with lithium metal as a counter electrode to obtain a dQ/dV curve, and the negative electrode plate has one reversible lithium intercalation peak and one reversible lithium deintercalation peak within a voltage range of 0 V to 0.4 V. An X-ray diffraction pattern of a graphite material has only a second characteristic peak and no first characteristic peak. The graphite material is used as a negative electrode active material to prepare a negative electrode plate. The negative electrode plate is subjected to charge and discharge test with lithium metal as a counter electrode to obtain a dQ/dV curve, and the negative electrode plate has three reversible lithium intercalation peaks and three reversible lithium deintercalation peaks within a voltage range of 0 V to 0.4 V. A mixture of the completely disordered hard carbon material and the graphite material is used as a negative electrode active material, and an X-ray diffraction pattern of the mixture has a first characteristic peak and a second characteristic peak. In addition, four reversible lithium intercalation peaks and four reversible lithium deintercalation peaks are present within a voltage range of 0 V to 0.4 V in a dQ/dV curve. However, the value of I2/I1 is greater than an upper limit value of the range in this application, and potential ranges used by the two active materials are different, which may lead to incomplete capacity utilization of some of the active materials, reducing the energy density of the secondary battery. In contrast, the X-ray diffraction pattern of the hard carbon material in this application has the first characteristic peak and the second characteristic peak. In addition, four reversible lithium intercalation peaks and three or four reversible lithium deintercalation peaks are present within the voltage range of 0 V to 0.4 V in the dQ/dV curve. Further, controlling the values of B−A and I2/I1 within the above ranges indicates that the hard carbon material in this application has a locally ordered graphitization structure inside. Since the locally ordered graphitization structure is introduced into the hard carbon material, as compared with the completely disordered hard carbon material, the hard carbon material has a high reversible capacity and an increased true density. When the hard carbon material in this application is used in the secondary battery, the energy density of the secondary battery can be increased. In addition, the locally ordered graphitization structure can shorten a lithium ion transport path in the hard carbon material, which is conducive to improving the kinetic performance of the secondary battery, thereby improving the cycling performance of the secondary battery. In this application, a peak intensity value of the highest point within a first characteristic peak range in an X-ray diffraction peak separation pattern after baseline correction is the peak intensity I1 of the first characteristic peak, and a peak intensity value of the highest point within a second characteristic peak range in the X-ray diffraction peak separation pattern after baseline correction is the peak intensity I2 of the second characteristic peak.

In an embodiment of this application, the hard carbon material has an internal pore structure, and a maximum inscribed circle diameter D of pores in the internal pore structure is 0.40 nm to 10 nm; preferably, D is 0.40 nm to 2 nm; and further preferably, D is 0.40 nm to 0.80 nm. For example, the maximum inscribed circle diameter D of the pores in the internal pore structure may be 0.40 nm, 0.50 nm, 0.60 nm, 0.80 nm, 1 nm, 1.3 nm, 1.5 nm, 1.7 nm, 2 nm, 3 nm, 4 nm, 5 nm, 6 nm, 7 nm, 8 nm, 9 nm, or 10 nm, or falls within a range defined by any two of these values. The hard carbon material having the internal pore structure is conducive to the storage of lithium ions during a lithium storage process, thereby allowing the hard carbon material to have a high reversible capacity. Controlling the maximum inscribed circle diameter of the pores in the internal pore structure of the hard carbon material within the above range allows an average lithium deintercalation potential of the negative electrode plate using the hard carbon material as the negative electrode active material and using lithium metal as the counter electrode to be within a low range. This is conducive to increasing the reversible capacity of the hard carbon material, especially a low voltage plateau capacity. The hard carbon material being used in the secondary battery is conducive to improving the energy density and first-cycle coulombic efficiency of the secondary battery, and improving the cycling performance of the secondary battery.

In an embodiment of this application, a surface of the hard carbon material has an external pore structure, and a pore volume V of the external pore structure obtained by adsorption test is less than or equal to 0.05 cc/g. For example, the pore volume V of the external pore structure obtained by adsorption test may be 0.01 cc/g, 0.02 cc/g, 0.03 cc/g, 0.04 cc/g, or 0.05 cc/g, or falls within a range defined by any two of these values. The pore volume of the external pore structure of the hard carbon material obtained by adsorption test is within the above range, indicating that the external pore volume of the hard carbon material in this application is small, which is conducive to improving the lithium storage performance of the hard carbon material, and reducing the irreversible capacity of the hard carbon material caused by the formation of a SEI (solid electrolyte interface) at the first cycle. The hard carbon material being used in the secondary battery is conducive to improving the energy density and first-cycle coulombic efficiency of the secondary battery, and improving the cycling performance of the secondary battery.

In an embodiment of this application, a true density p of the hard carbon material is 0.9 g/cc to 2.0 g/cc. For example, the true density p of the hard carbon material may be 0.9 g/cc, 1.0 g/cc, 1.3 g/cc, 1.5 g/cc, 1.7 g/cc, or 2.0 g/cc, or falls within a range defined by any two of these values. Controlling the true density of the hard carbon material within the above range allows the hard carbon material to have a lot of internal pore structures inside, facilitating storage of lithium ions or sodium ions, thereby allowing the hard carbon material to have a high reversible capacity. The hard carbon material being used in the secondary battery is conducive to improving the energy density and first-cycle coulombic efficiency of the secondary battery, and improving the cycling performance of the secondary battery.

In an embodiment of this application, a specific surface area S of the hard carbon material is 0.5 m²/g to 50 m²/g; and preferably, S is 0.5 m²/g to 5 m²/g. For example, the specific surface area S of the hard carbon material may be 0.5 m²/g, 1 m²/g, 3 m²/g, 5 m²/g, 7 m²/g, 10 m²/g, 13 m²/g, 15 m²/g, 17 m²/g, 20 m²/g, 23 m²/g, 25 m²/g, 27 m²/g, 30 m²/g, 33 m²/g, 35 m²/g, 37 m²/g, 40 m²/g, 43 m²/g, 45 m²/g, 47 m²/g, or 50 m²/g, or falls within a range defined by any two of these values. Controlling the specific surface area of the hard carbon material within the above range is conducive to forming a SEI film with a moderate area during the first charge process when the hard carbon material is used in the secondary battery. This reduces the amount of a negative electrode binder in a negative electrode active material layer, thereby reducing the loss of active ions such as lithium ions or sodium ions, and reducing the internal resistance of the negative electrode active material layer. Thus, this improves the energy density and first-cycle coulombic efficiency of the secondary battery, and improves the cycling performance and safety performance of the secondary battery.

In an embodiment of this application, Dᵥ50 of the hard carbon material is 3 μm to 12 μm, preferably 5 μm to 9 μm. For example, Dᵥ50 of the hard carbon material may be 3 μm, 4 μm, 5 μm, 6 μm, 7 μm, 8 μm, 9 μm, 10 μm, 11 μm, or 12 μm, or falls within a range defined by any two of these values. In this application, Dᵥ50 represents a particle size where the cumulative distribution by volume reaches 50% as counted from the small particle size side. Controlling Dᵥ50 of the hard carbon material within the above range through crushing and classification allows the hard carbon material particles to have good electrolyte infiltration performance and a small specific surface area, thereby reducing active ions such as lithium ions or sodium ions consumed by the formation of the SEI film on the surface of the hard carbon material particles during the first charge process. The hard carbon material being used in the secondary battery is conducive to improving the energy density and first-cycle coulombic efficiency of the secondary battery, and improving the cycling performance of the secondary battery.

In an embodiment of this application, the hard carbon material includes a heteroelement, where the heteroelement includes at least one of Li, Na, K, Cs, Mg, Al, Ca, Rb, Zn, Fe, Ni, Co, N, O, H, P, S, B, or Se, and based on a mass of the hard carbon material, a mass percentage X of the heteroelement is greater than 0 and less than or equal to 3%. For example, the mass percentage X of the heteroelement may be 0.01%, 0.03%, 0.05%, 0.07%, 0.1%, 0.3%, 0.5%, 0.7%, 1%, 1.3%, 1.5%, 1.7%, 2%, 2.3%, 2.5%, 2.7%, or 3%, or falls within a range defined by any two of these values. During preparation of a hard carbon material precursor, one or more catalysts are generally used. The catalyst can facilitate local graphitization of the hard carbon material at a low pyrolysis temperature, resulting in the possible retention of part of the heteroelement inside the hard carbon material. Controlling the mass percentage of the heteroelement within the above range is conducive to the local graphitization of the hard carbon material, improving the stability of the hard carbon material during an electrochemical reaction process, and allowing the hard carbon material to have a high specific capacity and first-cycle coulombic efficiency. The hard carbon material being used in the secondary battery is conducive to improving the energy density and first-cycle coulombic efficiency of the secondary battery, and improving the cycling performance of the secondary battery.

According to a second aspect of this application, a preparation method of a hard carbon material is provided, including the following steps.

(1) A reactant, a catalyst, and a solvent are well mixed to obtain a reaction solution, and the reaction solution is dried to obtain a precursor; where a mass ratio of the catalyst to the reactant is 0.01 to 1. For example, the mass ratio of the catalyst to the reactant may be 0.01, 0.03, 0.05, 0.07, 0.1, 0.3, 0.5, 0.7, or 1, or falls within a range defined by any two of these values. The reactant includes at least one of novolac resin, furfural resin, epoxy resin, asphalt, starch, glucose, sucrose, or fructose; the solvent includes at least one of ionized water, ethanol, benzene, toluene, or N-methylpyrrolidone; and the catalyst includes at least one of lithium hydroxide, sodium hydroxide, potassium hydroxide, magnesium hydroxide, cesium hydroxide, rubidium hydroxide, calcium hydroxide, aluminum hydroxide, alumina, aluminum oxide, zinc oxide, zinc chloride, iron, triiron tetraoxide, ferric chloride, ferric oxide, nickel oxide, nickel sulfate, nickel hydroxide, nickel chloride, cobalt nitrate, cobalt oxide, urea, phosphoric acid, lignin, boric acid, sodium selenate, sodium benzoate, potassium benzoate, or sodium cinnamate. [0041](2) The precursor is subjected to acid washing after a first carbonization treatment in an inert atmosphere, and is then subjected to a second carbonization treatment in the inert atmosphere to obtain a carbonization product. A temperature T1 of the first carbonization treatment is 500° C. to 900° C. For example, the temperature T1 of the first carbonization treatment may be 500° C., 530° C., 550° C., 570° C., 600° C., 630° C., 650° C., 670° C., 700° C., 730° C., 750° C., 770° C., 800° C., 830° C., 850° C., 870° C., or 900° C., or falls within a range defined by any two of these values. A time t1 of the first carbonization treatment is 0.5 h to 5 h. For example, the time t1 of the first carbonization treatment may be 0.5 h, 0.7 h, 1 h, 1.3 h, 1.5 h, 1.7 h, 2 h, 2.3 h, 2.5 h, 2.7 h, 3 h, 3.3 h, 3.5 h, 3.7 h, 4 h, 4.3 h, 4.5 h, 4.7 h, or 5 h or falls within a range defined by any two of these values. A heating velocity v1 of the first carbonization treatment is 0.5° C./min to 10° C./min. For example, the heating velocity v1 of the first carbonization treatment may be 0.5° C./min, 0.7° C./min, 1° C./min, 1.3° C./min, 1.5° C./min, 1.7° C./min, 2° C./min, 2.3° C./min, 2.5° C./min, 2.7° C./min, 3° C./min, 3.3° C./min, 3.5° C./min, 3.7° C./min, 4° C./min, 4.3° C./min, 4.5° C./min, 4.7° C./min, 5° C./min, 5.3° C./min, 5.5° C./min, 5.7° C./min, 6° C./min, 6.3° C./min, 6.5° C./min, 6.7° C./min, 7° C./min, 7.3° C./min, 7.5° C./min, 7.7° C./min, 8° C./min, 8.3° C./min, 8.5° C./min, 8.7° C./min, 9° C./min, 9.3° C./min, 9.5° C./min, 9.7° C./min, or 10° C./min, or falls within a range defined by any two of these values. A temperature T2 of the second carbonization treatment is 1000° C. to 1600° C. For example, the temperature T2 of the second carbonization treatment may be 1000° C., 1100° C., 1200° C., 1300° C., 1400° C., 1500° C., or 1600° C., or falls within a range defined by any two of these values. A time t2 of the second carbonization treatment is 0.5 h to 15 h. For example, the time t2 of the second carbonization treatment may be 0.5 h, 0.7 h, 1 h, 1.3 h, 1.5 h, 1.7 h, 2 h, 2.3 h, 2.5 h, 2.7 h, 3 h, 3.3 h, 3.5 h, 3.7 h, 4 h, 4.3 h, 4.5 h, 4.7 h, 5 h, 6 h, 7 h, 8 h, 9 h, 10 h, 11 h, 12 h, 13 h, 14 h, or 15 h, or falls within a range defined by any two of these values. A heating velocity v2 of the second carbonization treatment is 0.5° C./min to 10° C./min. For example, the heating velocity v2 of the second carbonization treatment may be 0.5° C./min, 0.7° C./min, 1° C./min, 1.3° C./min, 1.5° C./min, 1.7° C./min, 2° C./min, 2.3° C./min, 2.5° C./min, 2.7° C./min, 3° C./min, 3.3° C./min, 3.5° C./min, 3.7° C./min, 4° C./min, 4.3° C./min, 4.5° C./min, 4.7° C./min, 5° C./min, 5.3° C./min, 5.5° C./min, 5.7° C./min, 6° C./min, 6.3° C./min, 6.5° C./min, 6.7° C./min, 7° C./min, 7.3° C./min, 7.5° C./min, 7.7° C./min, 8° C./min, 8.3° C./min, 8.5° C./min, 8.7° C./min, 9° C./min, 9.3° C./min, 9.5° C./min, 9.7° C./min, or 10° C./min, or falls within a range defined by any two of these values.

(3) The carbonization product is heated to 500° C. to 1100° C. in the inert atmosphere at a heating velocity of 0.5° C./min to 20° C./min. For example, the heating velocity of the carbonization product in the inert atmosphere may be 0.5° C./min, 0.7° C./min, 1° C./min, 2° C./min, 3° C./min, 4° C./min, 5° C./min, 6° C./min, 7° C./min, 8° C./min, 9° C./min, 10° C./min, 11° C./min, 12° C./min, 13° C./min, 14° C./min, 15° C./min, 16° C./min, 17° C./min, 18° C./min, 19° C./min, or 20° C./min, or falls within a range defined by any two of these values. The carbonization product may be heated in the inert atmosphere to 500° C., 530° C., 550° C., 570° C., 600° C., 630° C., 650° C., 670° C., 700° C., 730° C., 750° C., 770° C., 800° C., 830° C., 850° C., 870° C., 900° C., 930° C., 950° C., 970° C., 1000° C., 1030° C., 1050° C., 1070° C., or 1100° C., or a temperature falling within a range defined by any two of these values. A heat preservation treatment is performed in a reducing atmosphere to obtain the hard carbon material, where the inert atmosphere includes at least one of a nitrogen gas, an argon gas, or a helium gas, and a time t3 of the heat preservation treatment is 0.1 h to 8 h. For example, the time t3 of the heat preservation treatment may be 0.1 h, 0.3 h, 0.5 h, 0.7 h, 1 h, 1.3 h, 1.5 h, 1.7 h, 2 h, 2.3 h, 2.5 h, 2.7 h, 3 h, 3.3 h, 3.5 h, 3.7 h, 4 h, 4.3 h, 4.5 h, 4.7 h, 5 h, 5.3 h, 5.5 h, 5.7 h, 6 h, 6.3 h, 6.5 h, 6.7 h, 7 h, 7.3 h, 7.5 h, 7.7 h, or 8 h, or falls within a range defined by any two of these values. The reducing atmosphere includes at least one of the argon gas, acetylene, or methane.

The inventors have found through research that catalyst components can form a melt with the reactant, facilitating rearrangement of internal atoms of the reactant, thereby making graphite microcrystals be precipitated; or the catalyst components can form a carbide with a carbon material, and the carbide is decomposed into graphite and catalyst elements at a high temperature. The catalyst and the reactant in the range of this application can facilitate the local graphitization of the reactant at a low pyrolysis temperature and can also facilitate the formation of the internal pore structure of the hard carbon material. In addition, during a process in which the catalyst acts with the reactant, part of a heteroelement such as oxygen or hydrogen is taken out together, so that the amount of the heteroelement in the hard carbon material is reduced. Thus, this is conducive to reducing irreversible reactions between the heteroelement and lithium ions during a lithium storage process of the hard carbon material, thereby increasing the reversible capacity of the hard carbon material. The first carbonization treatment and the second carbonization treatment facilitate the formation of the hard carbon material with local graphitization, the internal pore structure, and a small amount of heteroelement. Acid washing and the heat preservation treatment in the reducing atmosphere can further reduce the amount of the heteroelement in the hard carbon material, thereby improving the stability of the hard carbon material during an electrochemical reaction process, and facilitating the formation the hard carbon material within the range of this application. The method provided in the second aspect of this application is used for preparing a hard carbon material, and various parameters are controlled within the above range, so that the obtained hard carbon material has a high specific capacity and first-cycle coulombic efficiency. When the obtained hard carbon material is used in a negative electrode plate of a secondary battery, the energy density of the secondary battery can be increased, and the cycling performance of the secondary battery can be improved.

The mass ratio of the solvent to the reactant in the foregoing step (1) is not particularly limited in this application, provided that the objectives of this application can be achieved. For example, the mass ratio of the solvent to the reactant may be 0.1 to 8. A drying manner in the foregoing step (1) is not particularly limited in this application, provided that the objectives of this application can be achieved. For example, the drying manner may be spray drying. When the spray drying is performed, an inlet air temperature is set to be 130° C. to 300° C., and an outlet air temperature is set to be 50° C. to 150° C. It should be noted that if a mixing effect of part of the catalyst and the reactant is poor under the action of the solvent, the catalyst and the reactant at the same mass ratio can be placed into a reactor after mixed through ball milling or mechanically mixed, and then the solvent is added for reaction to obtain the precursor. A gas flow rate of the inert atmosphere in step (2) and step (3) is not particularly limited in this application, provided that the objectives of this application can be achieved. For example, the gas flow rate of the inert atmosphere may be 0.1 L/min to 30 L/min. A gas flow rate of the reducing atmosphere in step (3) is not specifically limited in this application, provided that the objectives of this application can be achieved. For example, the gas flow rate of the reducing atmosphere may be 0.1 L/min to 3 L/min.

In an embodiment of this application, after the heat preservation treatment in the foregoing step (3), the reducing atmosphere is replaced with the inert atmosphere, and then a secondary heat preservation treatment is performed. A temperature of the secondary heat preservation treatment is not particularly limited in this application, provided that the objectives of this application can be achieved. For example, the temperature of the secondary heat preservation treatment may be 900° C. to 1300° C., and a heat preservation time may be 1 h to 5 h. A smaller amount of heteroelement is present in the hard carbon material after the secondary heat preservation treatment, and the stability of the hard carbon material during the electrochemical reaction process is higher, allowing the hard carbon material to have a high specific capacity and first-cycle coulombic efficiency. The hard carbon material being used in the secondary battery is conducive to improving the energy density and first-cycle coulombic efficiency of the secondary battery, and improving the cycling performance of the secondary battery.

According to a third aspect of this application, a negative electrode plate is provided. The negative electrode plate includes a negative electrode current collector and a negative electrode active material layer disposed on at least one surface of the negative electrode current collector. The negative electrode active material layer includes the hard carbon material provided in the first aspect of this application or a hard carbon material prepared using the preparation method provided in the second aspect of this application. The negative electrode plate provided in the third aspect of this application has a high reversible capacity and good kinetic performance. When the negative electrode plate is used in a secondary battery, the energy density and first-cycle coulombic efficiency of the secondary battery can be improved, and the cycling performance of the secondary battery can be improved.

In an embodiment of this application, a compacted density PD of the negative electrode active material layer is 0.7 g/cm³ to 1.7 g/cm³. For example, the compacted density PD of the negative electrode active material layer is 0.7 g/cm³, 0.9 g/cm³, 1 g/cm³, 1.2 g/cm³, 1.4 g/cm³, or 1.5 g/cm³, 1.6 g/cm³, or 1.7 g/cm³, or falls within a range defined by any two of the foregoing values. A low compacted density of the negative electrode active material layer indicates that a lot of internal pore structures are present in the negative electrode active material layer, facilitating the infiltration of an electrolyte into negative electrode active material particles, thereby improving the cycling kinetic performance of the secondary battery. Further, the hard carbon material in this application has a high lithium storage capacity and low average lithium deintercalation potential. Controlling the compacted density of the negative electrode active material layer within the above range is conducive to increasing the volumetric energy density of the secondary battery. Therefore, the secondary battery has a high energy density and good cycling performance.

In an embodiment of this application, a porosity P of the negative electrode active material layer is 10% to 50%. For example, the porosity P of the negative electrode active material layer may be 10%, 12%, 15%, 17%, 20%, 22%, 25%, 27%, 30%, 32%, 35%, 37%, 40%, 42%, 45%, 47%, or 50%, or falls within a range defined by any two of these values. Controlling the porosity of the negative electrode active material layer within the above range facilitates the infiltration of the electrolyte into the negative electrode active material particles, thereby improving the cycling kinetic performance of the secondary battery, allowing contact points between the negative electrode active material particles to be within an appropriate range, balancing the internal resistance of the secondary battery, and increasing the volumetric energy density of the secondary battery.

In an embodiment of this application, in addition to the hard carbon material, the negative electrode active material layer may further include another negative electrode active material, for example, artificial graphite. The hard carbon material and the another negative electrode active material being used in combination is conducive to increasing the compacted density of the negative electrode active material layer, thereby increasing the energy density of the secondary battery.

The negative electrode current collector is not particularly limited in this application, provided that the objectives of this application can be achieved. For example, the negative electrode current collector may include a metal foil, a porous metal plate, or a composite current collector. The metal foil includes a copper foil, a copper alloy foil, a nickel foil, a stainless steel foil, or a titanium foil. The porous metal plate includes nickel foam or copper foam. The composite current collector may include a polymer material matrix and a metal layer formed on at least one surface of the polymer material matrix. The composite current collector may be formed by forming a metal material (copper, copper alloy, nickel, nickel alloy, titanium, titanium alloy, silver, silver alloy, or the like) on a polymer material matrix (for example, matrices of polypropylene (PP), polyethylene terephthalate (PET), polybutylene terephthalate (PBT), polystyrene (PS), and polyethylene (PE)). Thicknesses of the negative electrode current collector and the negative electrode active material layer are not particularly limited in this application, provided that the objectives of this application can be achieved. For example, the thickness of the negative electrode current collector is 4 m to 12 μm, and the thickness of the negative electrode active material layer applied on one surface is 30 μm to 200 μm. In this application, the negative electrode active material layer may be disposed on one surface of the negative electrode current collector in a thickness direction or may be disposed on two surfaces of the negative electrode current collector in the thickness direction. It should be noted that the “surface” herein may be an entire region of the negative electrode current collector or a partial region of the negative electrode current collector. This is not particularly limited in this application, provided that the objectives of this application can be achieved. The negative electrode active material layer in this application may further include a conductive agent and a negative electrode binder. The conductive agent and negative electrode binder in the negative electrode active material layer are not particularly limited in this application, provided that the objectives of this application can be achieved. For example, the conductive agent may include but is not limited to a carbon material, a metal, or a conductive polymer. The carbon material may include at least one of natural graphite, artificial graphite, superconducting carbon, acetylene black, carbon black, Ketjen black, carbon dots, carbon nanotubes, graphene, or carbon nanofiber. The metal may include metal powder or metal fiber of copper, iron, aluminum, or the like. The conductive polymer may include a polyphenylene derivative. The negative electrode binder may include but is not limited to at least one of polyvinyl alcohol, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, styrene-butadiene rubber, acrylic (ester) modified styrene-butadiene rubber, epoxy resin, or nylon. Optionally, the negative electrode active material layer further includes a thickener. The thickener may include but is not limited to sodium carboxymethyl cellulose.

The negative electrode plate in this application may be prepared using a conventional method in the art. For example, the hard carbon material or the hard carbon material and another optional negative electrode active material, the conductive agent, the negative electrode binder, and the thickener are dispersed in a solvent, where the solvent may be N-methylpyrrolidone (NMP) or deionized water. Then, a uniform negative electrode slurry is formed. The negative electrode slurry is then coated on the negative electrode current collector, followed by processes such as drying and cold pressing, to obtain the negative electrode plate.

The negative electrode plate in this application does not exclude another additional functional layer in addition to the negative electrode active material layer. For example, in an embodiment, the negative electrode plate in this application further includes a conductive primer layer (for example, consisting of a conductive agent and a negative electrode binder) disposed on a surface of the negative electrode current collector and sandwiched between the negative electrode current collector and the negative electrode active material layer. In another embodiment, the negative electrode plate in this application further includes a protective layer covering a surface of the negative electrode active material layer.

According to a fourth aspect of this application, a secondary battery is provided, including the negative electrode plate according to any one of the foregoing embodiments. The secondary battery provided in the fourth aspect of this application has a high energy density and first-cycle coulombic efficiency as well as good cycling performance.

The secondary battery in this application further includes a positive electrode plate. The positive electrode plate is not particularly limited in this application, provided that the objectives of this application can be achieved. For example, the positive electrode plate includes a positive electrode current collector and a positive electrode active material layer disposed on at least one surface of the positive electrode current collector. The positive electrode current collector is not particularly limited in this application, provided that the objectives of this application can be achieved. For example, the positive electrode current collector may include a metal foil or a composite current collector. For example, the metal foil is an aluminum foil. The composite current collector may include a polymer material matrix and a metal material layer formed on at least one surface of the polymer material matrix. For example, the material of the metal material layer may include at least one of aluminum, aluminum alloy, nickel, nickel alloy, titanium, titanium alloy, silver, or silver alloy. The polymer material matrix may include at least one of polypropylene, polyethylene terephthalate, polybutylene terephthalate, polystyrene, or polyethylene. The positive electrode active material layer in this application includes a positive electrode active material. The type of the positive electrode active material is not particularly limited in this application and can be selected based on actual needs, provided that the objectives of this application can be achieved.

In some embodiments, the secondary battery is a lithium-ion battery. The positive electrode active material may include lithium transition metal oxide. The lithium transition metal oxide may include but is not limited to lithium nickel cobalt manganese oxide (LiNi_{0.90} Co_{0.05}Mn_{0.05}O₂ (NCM955), NCM811, NCM622, NCM523, or NCM111), lithium nickel cobalt aluminum oxide, lithium iron phosphate, lithium-rich manganese-based material, lithium cobalt oxide (LiCoO₂), lithium manganate, lithium manganese iron phosphate, or lithium titanate. In some other embodiments, the secondary battery is a sodium-ion battery. The positive electrode active material may include at least one of a sodium transition metal oxide, a polyanionic compound, or a Prussian blue compound. The sodium transition metal oxide may include Na₁₋ₓ CuₕFeₖMnₗM¹ₘO_{2-y}, Na_{0.67}Mn_{0.7}Ni_{z}M²_{0.3-z}O₂, and NaₐLi_{b}Ni_{c}Mn_{d}FeₑO₂, where M¹ is at least one of Li, Be, B, Mg, Al, K, Ca, Ti, Co, Ni, Zn, Ga, Sr, Y, Nb, Mo, In, Sn, or Ba; 0<x≤0.33; 0<h≤0.24; 0≤k≤0.32; 0<l≤0.68; 0≤m<0.1; h+k+l+m=1; 0≤y<0.2; M² is at least one of Li, Mg, Al, Ca, Ti, Fe, Cu, Zn, or Ba; 0<z≤0.1; 0.67<a≤1; 0<b<0.2; 0<c<0.3; 0.67<d+e<0.8; and b+c+d+e=1. The polyanionic compound may include but is not limited to A¹_{f}M³_{g}(PO₄)ᵢOⱼX¹₃₋ⱼ, NaₙM⁴PO₄X², NaₚM⁵_{q}(SO₄)₃, and NaₛMnₜFe₃₋ₜ(PO₄)₂(P₂O₇), where A¹ is at least one of H, Li, Na, K, or NH₄; M³ is at least one of Ti, Cr, Mn, Fe, Co, Ni, V, Cu, or Zn; X¹ is at least one of F, Cl, or Br; 0<f≤4; 0<g≤2; 1≤i≤3, 0≤j≤2; M⁴ is at least one of Mn, Fe, Co, Ni, Cu, or Zn; X² is at least one of F, Cl, or Br; 0<n≤2; M⁵ is at least one of Mn, Fe, Co, Ni, Cu, or Zn; 0<p≤2; 0<q≤2; 0<s≤4; and 0≤t≤3. The Prussian blue compound may include but is not limited to A²ᵤM⁶ᵥ[M⁷(CN)₆]_{w}·xH₂O, where A² is one or more selected from a group consisting of H⁺, NH₄⁺, alkali metal cations, and alkaline earth metal cations; M⁶ and M⁷ are each at least one of transition metal cations; 0<u≤2; 0<v≤1; 0<w≤1; and 0<x<6. For example, A² is at least one of H⁺, Li⁺, Na⁺, K⁺, NH₄⁺, Rb⁺, Cs⁺, Fr⁺, Be²⁺, Mg²⁺, Ca²⁺, Sr²⁺, Ba²⁺, or Ra²⁺; and M⁶ and M⁷ are each independently a cation of at least one transition metal element of Ti, V, Cr, Mn, Fe, Co, Ni, Cu, Zn, Sn, or W. Preferably, A² is at least one of Li+, Na+, or K+; M⁶ is a cation of at least one transition metal element of Mn, Fe, Co, Ni, or Cu; and M⁷ is a cation of at least one transition metal element of Mn, Fe, Co, Ni, or Cu.

Thicknesses of the positive electrode current collector and the positive electrode active material layer are not particularly limited in this application, provided that the objectives of this application can be achieved. For example, the thickness of the positive electrode current collector is 5 μm to 20 μm, preferably 6 μm to 18 μm. The thickness of the positive electrode active material layer applied on one surface is m to 400 μm. In this application, the positive electrode active material layer may be disposed on one surface of the positive electrode current collector in a thickness direction or may be disposed on two surfaces of the positive electrode current collector in the thickness direction. It should be noted that the “surface” herein may be an entire region of the positive electrode current collector or a partial region of the positive electrode current collector. This is not particularly limited in this application, provided that the objectives of this application can be achieved. The positive electrode active material layer in this application may further include a conductive agent and a positive electrode binder. The type of the conductive agent in the positive electrode active material layer is not particularly limited in this application, provided that the objectives of this application can be achieved. For example, the conductive agent may be of the same type as the conductive agent in the foregoing negative electrode active material layer. The type of the positive electrode binder in the positive electrode active material layer is not particularly limited in this application, provided that the objectives of this application can be achieved. For example, the positive electrode binder may be of the same type as the negative electrode binder in the foregoing negative electrode active material layer. A mass ratio of the positive electrode active material, conductive agent, and positive electrode binder in the positive electrode active material layer is not particularly limited in this application and can be chosen by persons skilled in the art based on actual needs, provided that the objectives of this application can be achieved.

The positive electrode plate in this application may be prepared using a conventional method in the art. For example, the positive electrode active material layer is typically formed by applying a positive electrode slurry on the positive electrode current collector, followed by drying and cold pressing. The positive electrode slurry is typically formed by dispersing the positive electrode active material, the optional selectable conductive agent, the optional positive electrode binder, and any other constituents into a solvent and then stirring them to uniformity. The solvent may be but is not limited to N-methylpyrrolidone (NMP).

The positive electrode plate in this application does not exclude another additional functional layer in addition to the positive electrode active material layer. For example, in an embodiment, the positive electrode plate in this application further includes a conductive primer layer (for example, consisting of a conductive agent and a binder) disposed on a surface of the positive electrode current collector and sandwiched between the positive electrode current collector and the positive electrode active material layer. In another embodiment, the positive electrode plate in this application further includes a protective layer covering a surface of the positive electrode active material layer.

The secondary battery in this application further includes an electrolyte. In an embodiment, the electrolyte may include an organic solvent, an electrolytic salt, and an optional additive. The types of the organic solvent, a lithium salt, and the additive are not specifically limited and can be selected based on needs. In an embodiment, the secondary battery is a lithium-ion battery. The electrolytic salt may include a lithium salt. The lithium salt may include but is not limited to at least one of lithium hexafluorophosphate (LiPF₆), lithium tetrafluoroborate (LiBF₄), lithium perchlorate (LiClO₄), lithium bis(fluorosulfonyl)imide (LiFSI), lithium bis(trifluoromethanesulfonyl)imide (LiTFSI), lithium trifluoromethanesulfonate (LiTFS), lithium difluoro(oxalate)borate (LiDFOB), lithium bis(oxalate)borate (LiBOB), lithium difluorophosphate (LiPO₂F₂), lithium difluoro(oxalato)phosphate (LiDFOP), or lithium tetrafluoro(oxalato)phosphate (LiTFOP). The concentration of the lithium salt in the electrolyte is not particularly limited in this application, provided that the objectives of this application can be achieved. In another embodiment, the secondary battery is a sodium-ion battery. The electrolytic salt may include a sodium salt. The sodium salt may include but is not limited to at least one of NaPF₆, NaClO₄, NaBCl₄, NaSO₃ CF₃, or Na(CH₃)C₆H₄SO₃. The concentration of the sodium salt in the electrolyte is not particularly limited in this application, provided that the objectives of this application can be achieved.

The organic solvent is not particularly limited in this application, provided that the objectives of this application can be achieved. For example, the organic solvent may include but is not limited to at least one of a carbonate compound, a carboxylate compound, an ether compound, or another non-aqueous organic solvent. The carbonate compound may include but is not limited to at least one of a linear carbonate compound, a cyclic carbonate compound, or a fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonate may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate (MF), methyl acetate (MA), ethyl acetate (EA), propyl acetate (PA), n-propyl acetate, tert-butyl acetate, methyl propionate (MP), ethyl propionate (EP), propyl propionate (PP), ethyl butyrate (EB), gamma butyrolactone (GBL), decalactone, valerolactone, or hexalactone. The ether compound may include but is not limited to at least one of dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran. The another non-aqueous organic solvent may include but is not limited to at least one of methyl sulfonyl methane (MSM), ethyl methyl sulfone (EMS), diethyl sulfone (ESE), sulfolane (SF), 1,2-dioxolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

In an embodiment, the additive may include a negative electrode film-forming additive and a positive electrode film-forming additive, and may further include an additive capable of improving some performance of a battery, for example, an additive for improving overcharge performance of the battery, or an additive for improving high-temperature performance or low-temperature performance of the battery. The additive may include but is not limited to at least one of fluoroethylene carbonate (FEC), vinylene carbonate (VC), vinyl ethylene carbonate (VEC), ethylene sulfate (DTD), propylene sulfate, ethylene sulfite (ES), 1,3-propane sultone (PS), 1,3-propene sultone (PST), sulfonate cyclic quaternary ammonium salt, succinic anhydride, succinonitrile (SN), adiponitrile (ADN), tris(trimethylsilyl)phosphate (TMSP), or tris(trimethylsilyl)borate (TMSB).

The electrolyte may be prepared using a conventional method in the art. For example, the electrolyte can be obtained by mixing the organic solvent, the electrolytic salt, and the optional additive to uniformity. There is no particular limitation on the order of adding the materials. For example, the electrolytic salt and the optional additive are added into the organic solvent and mixed to uniformity to obtain the electrolyte; or the electrolytic salt is first added into the organic solvent, then the optional additive is added into the organic solvent, and then the materials are mixed to uniformity to obtain the electrolyte.

The secondary battery in this application further includes a separator, where the separator is used to separate the positive electrode plate from the negative electrode plate, prevent internal short circuits of the secondary battery, allow for free passage of electrolyte ions, and not affect the electrochemical charge and discharge process. The separator is not particularly limited in this application, provided that the objectives of this application can be achieved. For example, the material of the separator may include but is not limited to at least one of polyethylene (PE) and polypropylene (PP)-based polyolefin (PO), polyester (for example, a polyethylene terephthalate (PET) film), cellulose, polyimide (PI), polyamide (PA), spandex, or aramid. The type of the separator may include at least one of a woven film, a nonwoven film, a microporous film, a composite film, a laminated film, or a spinning film. The separator in this application may have a porous structure. The pore size of the porous structure of the separator is not particularly limited in this application, provided that the objectives of this application can be achieved. For example, the pore size may be 0.01 μm to 1 μm. The thickness of the separator is not particularly limited in this application, provided that the objectives of this application can be achieved. For example, the thickness of the separator may be 3 μm to 20 μm.

The secondary battery in this application further includes an outer package for accommodating the positive electrode plate, the separator, the negative electrode plate, the electrolyte, and another component of the secondary battery known in the art. The another component is not limited in this application. The outer package is not particularly limited in this application, provided that the objectives of this application can be achieved. In an embodiment, the outer package may be a hard shell, for example, a hard plastic shell, an aluminum shell, or a steel shell. In another embodiment, the outer package may alternatively be a soft pack, for example, a soft pouch. The material of the soft pack may be plastic. For example, the plastic may include but is not limited to at least one of polypropylene (PP), polybutylene terephthalate (PBT), or polybutylene succinate (PBS).

The secondary battery in this application is not particularly limited and may include any apparatus in which electrochemical reactions take place. In an embodiment of this application, the secondary battery may include but is not limited to a lithium-ion battery, a sodium-ion battery, a lithium polymer secondary battery, or a lithium-ion polymer secondary battery. The shape of the secondary battery is not particularly limited in this application, and the secondary battery may be cylindrical, rectangular, or of any other shapes.

A preparation process of the secondary battery in this application is well known to persons skilled in the art and is not particularly limited in this application. For example, the preparation process may include but is not limited to the following steps: The positive electrode plate, the separator, and the negative electrode plate are stacked sequentially, and the resulting stack is subjected to operations such as winding and folding to obtain an electrode assembly with a wound structure; and then the electrode assembly is put into a packaging bag, the electrolyte is injected into the packaging bag, and sealing is performed to obtain the secondary battery. Alternatively, the positive electrode plate, the separator, and the negative electrode plate are stacked sequentially, then four corners of an entire laminated structure are fastened by an adhesive tape to obtain an electrode assembly with the laminated structure; and then the electrode assembly is put into the packaging bag, the electrolyte is injected into the packaging bag, and sealing is performed to obtain the secondary battery. In addition, an overcurrent prevention element, a guide plate, and the like may also be placed in the packaging bag based on needs, so as to prevent pressure increase, overcharge, and overdischarge in the secondary battery.

According to a fifth aspect of this application, an electric apparatus is provided, including the secondary battery according to any one of the foregoing embodiments. The secondary battery provided in this application has a high energy density and first-cycle coulombic efficiency as well as good cycling performance. Therefore, the electric apparatus in this application has a long service life.

The electric apparatus in this application is not particularly limited and may be any electronic device known in the prior art. For example, the electric apparatus may include but is not limited to a notebook computer, a pen-input computer, a mobile computer, an electronic book player, a portable telephone, a portable fax machine, a portable copier, a portable printer, a stereo headset, a video recorder, a liquid crystal display television, a portable cleaner, a portable CD player, a mini-disc, a transceiver, an electronic notebook, a calculator, a storage card, a portable recorder, a radio, a backup power supply, a motor, an automobile, a motorcycle, a motor bicycle, a bicycle, a lighting appliance, a toy, a game console, a clock, an electric tool, a flash lamp, a camera, a large household storage battery, and a lithium-ion capacitor.

### EXAMPLE

The following describes some embodiments of this application more specifically by using examples and comparative examples. Various tests and evaluations are performed in the following methods. In addition, unless otherwise specified, “part” and “%” are based on mass.

### Test Method and Device

### Method for Sampling Negative Electrode Plate and Negative Electrode Active Material

A lithium-ion battery was discharged to 2.0 V at 0.2 C and then disassembled. Then, a negative electrode plate was taken out, soaked with dimethyl carbonate (DMC) for 20 min, and then sequentially rinsed with DMC and acetone once. Then, the negative electrode plate was placed in an oven and baked at 80° C. for 12 hours to obtain a treated negative electrode plate sample. The above method was used to sample negative electrode plate samples in the following tests: a compacted density PD test a negative electrode active material layer; and a porosity P test of a negative electrode active material layer.

The negative electrode active material layer was scraped off the negative electrode plate with a scraper, and the scraped powder was heated at 400° C. for 4 hours in a tube furnace under the protection of an argon gas, to obtain a negative electrode active material powder sample. The above method was used to sample negative electrode active material samples in the following tests: an X-ray diffraction (XRD) test; a gram capacity and first-cycle efficiency test of a negative electrode active material; a test of a maximum inscribed circle diameter D of pores in an internal pore structure; a pore volume V test of an external pore structure; a true density p test of a negative electrode active material; a Dᵥ50 test of a negative electrode active material; a specific surface area S test of a negative electrode active material; and an element analysis test.

### X-Ray Diffraction (XRD) Test

An X-ray powder diffractometer (XRD, where the instrument model was Bruker D8 ADVANCE) was used to test a negative electrode active material. Test parameters were as follows: a target material was Cu Kα; a voltage was 30 kV; and a current was 10 mA.

### Gram Capacity and First-Cycle Efficiency Test of Negative Electrode Active Material

A negative electrode active material, binder styrene-butadiene rubber, and sodium carboxymethyl cellulose (CMC-Na) were mixed at a mass ratio of 97:1.5:1.5. Then, deionized water was added as a solvent, and the resulting mixture was well stirred to prepare a negative electrode slurry with a solid content of 40 wt %. The negative electrode slurry was uniformly coated on one surface of a negative electrode current collector copper foil with a thickness of 10 m; and then drying was performed at 85° C. to obtain a negative electrode plate. The negative electrode plate was cut into discs with a diameter of 14 mm to be used as a working electrode. A lithium metal plate was used as a counter electrode, and a polyethylene (PE) film with a thickness of 7 μm was used as a separator. After a test electrolyte was injected, a button battery was assembled. The button battery was subjected to charge and discharge cycles. The button battery was first discharged to 0 mV at 0.05 C and then discharged to 20 μA at a constant voltage of 0 mV, and a first-cycle discharge specific capacity of the button battery was recorded. Then, the button battery was charged to 2.5 V at a constant current of 0.05 C, and a first-cycle charge specific capacity of the button battery was recorded. The mass of the negative electrode active material in the negative electrode plate was calculated based on a coating weight and area of the negative electrode slurry in the above electrode plate preparation process. First-cycle efficiency=first-cycle charge specific capacity/first-cycle discharge specific capacity×100%. Gram capacity Q of negative electrode active material=first-cycle discharge specific capacity/mass of negative electrode active material, in mAh/g. A gram capacity-voltage curve was differentiated to obtain a dQ/dV curve, and the number of reversible lithium intercalation peaks and the number of reversible lithium deintercalation peaks within a voltage range of 0 V to 0.4 V of the negative electrode plate were recorded. Specific preparation parameters and steps of the test electrolyte were the same as those of the electrolyte in Example 1.

### Test of Maximum Inscribed Circle Diameter D of Pores in Internal Pore Structure

A small-angle X-ray scattering test was performed to obtain a scattering intensity variation of a scattering vector of a negative electrode active material sample under test within a range of 0.01 nm⁻¹ to 7⁻¹ nm. Information of an internal pore structure of a negative electrode active material was obtained through calculation. Further, a high-resolution transmission electron microscopy (HRTEM) was used to intuitively observe the pore structure of the hard carbon material. Specifically, the negative electrode active material was coated with epoxy resin and cured. Then, an ultrathin slicing method was used to cut the negative electrode active material under test into a size of 20 nm to 150 nm to obtain a sample. The high-resolution transmission electron microscopy (HRTEM) was used to observe a selected particle sample section. Carbon microcrystals and pores could be distinguished based on shading contrast differences in HRTEM images. The criteria for determining the pores in the internal pore structure were as follows: In a defined region range, no microcrystal layer was present, and the range was in a blank state and was surrounded by the microcrystal layer. Five randomly selected clear regions with a size of 10 nm×10 nm were analyzed. Pore sizes were measured using image analysis software, and a range of the maximum inscribed circle diameter D of the pores in the internal pore structure was determined.

### Pore Volume V Test of External Pore Structure

An ASAP2460 physical adsorption analyzer was used to test a pore volume of an external pore structure of a negative electrode active material. Specifically, after the negative electrode active material under test was taken and subjected to pretreatment through drying and degassing, the ASAP2460 physical adsorption analyzer was used to test an adsorption amount of a nitrogen gas as a test gas by the negative electrode active material at different pressures, and adsorption and desorption isotherms were drawn. The shape of a pore was determined based on the shape of a hysteresis loop; a micropore size distribution curve was fitted using a DFT model; and the pore volume V of the external pore structure of the negative electrode active material was then obtained.

### True Density p Test of Negative Electrode Active Material

A true density p of a negative electrode active material under test was tested using a true density meter according to the standard GB/T24586-2009 Determination of Apparent Density, True Density, and Porosity of Iron Ore.

### Dᵥ50 Test of Negative Electrode Active Material

A negative electrode active material under test was taken, and the particle size distribution of the negative electrode active material was determined using a laser diffraction particle size analyzer (Malvern, UK, where the model was Mastersizer 2000E) according to the standard GB/T 19077-2016 Particle Size Distribution Laser Diffraction Method.

### Specific Surface Area S Test of Negative Electrode Active Material

A negative electrode active material under test was dried in a vacuum drying oven and then loaded into a sample tube. A specific surface area S of the negative electrode active material was tested using a specific surface area analyzer (Tristar II 3020M) through a nitrogen gas adsorption/desorption method. The specific test was performed according to the standard GB/T 19587-2017 Gas Adsorption BET Method for Determining the Specific Surface Area of Solid Materials.

### Element Analysis Test

A mass ratio a of an element with a large atomic mass to carbon in the hard carbon material was determined using an inductively coupled plasma optical emission spectrometer (ICP-OES). 0.5 g of a negative electrode active material under test was weighed and mixed with 10 mL concentrated HNO₃. Microwave digestion was performed. A solution after digestion was introduced into an inductively coupled photoelectron (ICP) light source. An ICP-OES was used to test amounts of different substances based on characteristic radiation energy emitted by radiation transition generated when outer electrons of excited gaseous atoms in a sample substance returned from an excited state to a ground state. An element with a small relative atomic mass in the hard carbon material could be tested using an elemental analyzer (Company: Elementar, Model: Unicube). The hard carbon material sample obtained in the above step was tested in a carbon, hydrogen, and nitrogen (CHN) mode and an oxygen (O) mode, and mass percentages of C, H, O, and N elements in the hard carbon material were respectively tested to obtain a mass percentage b of the element with the small atomic mass in the hard carbon material. A percentage X of a heteroelement in the hard carbon particles was equal to a+b. When X was less than 0.01%, the percentage of the heteroelement in the hard carbon material was negligible, and X was recorded as being less than 0.01%.

### Compacted Density PD Test of Negative Electrode Active Material Layer

An electronic balance was used to weigh a negative electrode plate with an area S, where the weight was recorded as W₁; and a micrometer was used to measure a thickness T₁ of the negative electrode plate. A negative electrode active material layer was washed off with a solvent DMC. Drying was performed, then the weight of a negative electrode current collector was measured and recorded as W₂; and the micrometer was used to measure a thickness T₂ of the negative electrode current collector. A compacted density PD of a negative electrode active material layer disposed on one side of the negative electrode current collector was equal to (W₁−W₂)/[(T₁−T₂)S].

### Porosity P Test of Negative Electrode Active Material Layer

A negative electrode active material layer sample under test was prepared into a complete disc, and 30 samples were tested in each example or comparative example, where a volume of each sample was 0.35 cm³. A true density ρ′ of a negative electrode active material layer in each example or comparative example was tested using a true density meter according to the standard GB/T24586-2009 Determination of Apparent Density, True Density, and Porosity of Iron Ore. An apparent density ρ″ of the negative electrode active material layer in each example or comparative example was tested. A porosity P of negative electrode active material layer was equal to (ρ′−ρ″)/ρ′.

### Energy Density Test

Five lithium-ion batteries were taken from each group of lithium-ion batteries under test and then charged and discharged for the first time in an environment at 25° C. Each lithium-ion battery was constant-current and constant-voltage charged to an upper limit voltage at a charge current of 0.5 C, and then constant-current discharged to 3.0 V at a discharge current of 0.2 C. A discharge capacity and average discharge voltage of the lithium-ion battery were obtained. The length, width, and thickness of the lithium-ion battery at 50% SOC were measured. The volume of the lithium-ion battery was obtained through calculation. A volumetric energy density of the lithium-ion battery obtained through calculation was equal to the discharge capacity of the lithium-ion battery×the average discharge voltage of the lithium-ion battery/the volume of the lithium-ion battery. An energy density percentage of each example and each comparative example with respect to Comparative example 1 was further calculated.

A lithium-ion battery with a negative electrode active material including graphite had a charge upper limit voltage of 4.48 V and a discharge cut-off voltage of 3.0 V. Alithium-ion battery in an example in which a negative electrode active material included only the hard carbon material had a charge upper limit voltage of 4.53 V and a discharge cut-off voltage of 2.0 V.

### Cycling Performance Test

Five lithium-ion batteries were taken from each group of lithium-ion batteries under test and then repeatedly charged and discharged in the following steps; and a discharge capacity retention rate of each lithium-ion battery was calculated.

Each lithium-ion battery was charged and discharged for the first time in an environment at 25° C., where the lithium-ion battery was constant-current charged at a charge current of 1 C and then constant-voltage charged after the voltage reached an upper limit voltage. Then, the lithium-ion battery was constant-current discharged at a discharge current of 1 C until the voltage reached a discharge cut-off voltage. A discharge capacity at the first cycle was recorded. Then, 800 charge and discharge cycles were performed, and a discharge capacity at the 800th cycle was recorded. A lithium-ion battery with a negative electrode active material including graphite had a charge upper limit voltage of 4.48 V and a discharge cut-off voltage of 3.0 V. A lithium-ion battery with a negative electrode active material including only the hard carbon material had a charge upper limit voltage of 4.53 V and a discharge cut-off voltage of 2.0 V.

Cycling capacity retention rate (%)=(discharge capacity at the 800th cycle/discharge capacity at the first cycle)×100%.

### Test of High-Temperature Discharge Performance and Low-Temperature Discharge Performance of Lithium-Ion Battery

Five lithium-ion batteries were taken from each group of lithium-ion batteries under test and then charged in an environment at 25° C., where each lithium-ion battery was constant-current and constant-voltage charged to an upper limit voltage at a charge current of 0.5 C. Then, a fully charged lithium-ion battery was sequentially left standing for 1 h in environments at 25° C., −20° C., and 45° C., respectively, and then constant-current discharged to a cut-off voltage at a discharge current of 0.2 C. Capacity values D_{R}, D_{L}, D_{H} of the lithium-ion battery were obtained respectively. A low-temperature capacity retention rate of the lithium-ion battery (%)=D_{L}/D_{R}×100%. The low-temperature capacity retention rate of the lithium-ion battery (%)=D_{H}/D_{R}×1000.

A lithium-ion battery with a negative electrode active material including graphite had a charge upper limit voltage of 4.48 V and a discharge cut-off voltage of 3.0 V A lithium-ion battery with a negative electrode active material including only the hard carbon material had a charge upper limit voltage of 4.53 V and a discharge cut-off voltage of 2.0 V.

### Example 1

### <Preparation of Hard Carbon Material>

(1) 200 g of reactant starch and 28.05 g of catalyst potassium hydroxide were added into 300 g of solvent deionized water, stirred well, and dissolved to obtain a reaction solution. Then, the reaction solution was subjected to spray drying to obtain a precursor, where a mass ratio of the catalyst to the reactant was 0.14.

(2) The precursor was subjected to a first carbonization treatment in an inert atmosphere being a nitrogen gas to obtain a first carbonization treatment product, where a heating velocity v1 of the first carbonization treatment was 3° C./min, a temperature T1 of the first carbonization treatment was 900° C., and a time t1 of the first carbonization treatment was 4 h. The first carbonization treatment product was added into 500 mL hydrochloric acid solution with a concentration of 1 mol/L, heated to 80° C., and subjected to reflux stirring for 12 h for acid washing to remove impurities. Then, suction filtration and collection were performed, and rinsing was performed three times. Then, suction filtration and drying were performed to obtain an acid-washed product. Then, the acid-washed product was subjected to a second carbonization treatment in the inert atmosphere being the nitrogen gas to obtain a carbonization product. A heating velocity v2 of the second carbonization treatment was 5° C./min, a temperature T2 of the second carbonization treatment was 1200° C., and a time t2 of the second carbonization treatment was 4 h.

(3) The carbonization product was heated to 900° C. in the inert atmosphere being the nitrogen gas at a heating velocity of 1° C./min. Then, the inert atmosphere was replaced with a mixed gas of 5 wt % methane and an argon gas at a flow rate of 0.5 L/min. A heat preservation time t3 was 2 h. A hard carbon material was obtained.

### <Preparation of Negative Electrode Plate>

A negative electrode active material hard carbon material, binder styrene-butadiene rubber, and sodium carboxymethyl cellulose (CMC-Na) were mixed at a mass ratio of 97:1.5:1.5. Then, deionized water was added as a solvent, and the resulting mixture was well stirred to prepare a negative electrode slurry with a solid content of 40 wt %. The negative electrode slurry was uniformly coated on one surface of a negative electrode current collector copper foil with a thickness of 6 m; and then drying was performed at 85° C. to obtain a negative electrode plate, where one surface of the negative electrode plate was coated with a negative electrode active material layer with a thickness of 80 μm. The above steps were repeated on another surface of the negative electrode current collector copper foil to obtain a negative electrode plate, where two surfaces of the negative electrode plate were coated with negative electrode active material layers. Then, cold pressing, cutting, and slitting were performed to obtain a negative electrode plate.

### <Preparation of Positive Electrode Plate>

A positive electrode active material lithium cobalt oxide, conductive carbon black (Super P), and polyvinylidene fluoride (PVDF) were mixed at a mass ratio of 97:1.4:1.6. Then, N-methylpyrrolidone (NMP) was added as a solvent, and the resulting mixture was well stirred to prepare a positive electrode slurry with a solid content of 72 wt %. The positive electrode slurry was uniformly coated on one surface of a positive electrode current collector aluminum foil with a thickness of 10 m; and then drying was performed at 85° C. to obtain a positive electrode plate, where one surface of the positive electrode plate was coated with a positive electrode active material layer. The above steps were repeated on another surface of the positive electrode current collector aluminum foil to obtain a positive electrode plate, where two surfaces of the positive electrode plate were coated with positive electrode active material layers. Then, after cold pressing, cutting, and slitting, a positive electrode plate was obtained, and a negative electrode/positive electrode N/P ratio was set to 1.0. In other words, a ratio of a negative electrode capacity per unit area to a positive electrode capacity per unit area was 1.0.

### <Preparation of Electrolyte>

In a dry argon atmosphere glove box, ethylene carbonate (EC), propylene carbonate (PC), and diethyl carbonate (DEC) were mixed at a mass ratio of 1:1:1 to obtain an organic solvent. A lithium salt LiPF₆ was dissolved in the organic solvent, then fluoroethylene carbonate (FEC) was added. Then, the resulting solution was well mixed to obtain an electrolyte. Based on a total mass of the electrolyte, a mass percentage of LiPF₆ was 12.5%, a mass percentage of FEC was 5%, and the rest was the organic solvent.

### <Separator>

A polyethylene (PE) film with a thickness of 7 μm was used as a separator.

### <Preparation of a Lithium-Ion Battery>

The prepared positive electrode plate, separator, and negative electrode plate were stacked sequentially, so that the separator was located between the positive electrode plate and the negative electrode plate for separation, and the resulting stack was wound to obtain an electrode assembly. After tab welding, the electrode assembly was placed into an aluminum-plastic film packaging bag and then dried in an 80° C. vacuum oven for 12 hours to remove moisture. Then, the prepared electrolyte was injected. Then, processes such as vacuum sealing, standing, formation, degassing, and trimming were performed to obtain a lithium-ion battery. A design potential range of the lithium-ion battery was 2.0 V to 4.53 V.

### Examples 2 to 7

These examples were the same as Example 1 except that the amounts of catalyst potassium hydroxide in <preparation of hard carbon material> were 14.03 g, 10.10 g, 8.98 g, 7.86 g, 6.73 g, and 5.61 g, respectively.

### Examples 8 to 12

These examples were the same as Example 4 except that the times t2 of the second carbonization treatment in <preparation of hard carbon material> were 12 h, 8 h, 3 h, 2 h, and 1 h, respectively.

### Example 13

This example was the same as Example 4 except for the preparation of the hard carbon material in the following steps.

### <Preparation of Hard Carbon Material>

(1) 200 g of reactant starch and 8.98 g of catalyst potassium hydroxide were added into 300 g of solvent deionized water, stirred well, and dissolved to obtain a reaction solution. Then, the reaction solution was subjected to spray drying to obtain a precursor, where a mass ratio of the catalyst to the reactant was 0.0449.

(2) The precursor was subjected to a first carbonization treatment in an inert atmosphere being a nitrogen gas to obtain a first carbonization treatment product, where a heating velocity v1 of the first carbonization treatment was 3° C./min, a temperature T1 of the first carbonization treatment was 900° C., and a time t1 of the first carbonization treatment was 4 h. The first carbonization treatment product was added into 500 mL mixed solution with 2 mol/L hydrochloric acid and 1 mol/L hydrochloric acid, heated to 80° C., and subjected to reflux stirring for 12 h for acid washing to remove impurities. Then, suction filtration and collection were performed, and rinsing was performed three times. Then, suction filtration and drying were performed to obtain an acid-washed product. Then, the acid-washed product was subjected to a second carbonization treatment in the inert atmosphere being the nitrogen gas to obtain a carbonization product. A heating velocity v2 of the second carbonization treatment was 5° C./min, a temperature T2 of the second carbonization treatment was 1200° C., and a time t2 of the second carbonization treatment was 12 h.

(3) The carbonization product was heated to 900° C. in the inert atmosphere being the nitrogen gas at a heating velocity of 1° C./min. Then, the inert atmosphere was replaced with a mixed gas of 5 wt % methane and an argon gas at a flow rate of 0.5 L/min. A heat preservation time t3 was 2 h. Then, the carbonization product was heated to 1200° C. in the inert atmosphere being the nitrogen gas at a heating velocity of 1° C./min, and a heat preservation time t4 was 2 h. A hard carbon material was obtained.

### Examples 14 to 16

These examples were the same as Example 4 except that Dᵥ50 of the hard carbon active materials in Examples 14 to 16 were set to 12.0 μm, 4.7 μm, and 1.3 m respectively through crushing and classification in <preparation of hard carbon material>.

### Comparative Example 1

This comparative example was the same as Example 1, except that the negative electrode active material hard carbon material was replaced with the negative electrode active material artificial graphite in <preparation of negative electrode plate>, the negative electrode/positive electrode N/P ratio was set to 1.04, and the design potential range of the lithium-ion battery was adjusted to 3.0 V to 4.48 V in <preparation of lithium-ion battery>.

### Comparative Example 2

This comparative example was the same as Example 1 except that no catalyst potassium hydroxide was added in <preparation of hard carbon material>.

### Comparative Example 3

This comparative example was the same as Example 1 except for the preparation of the hard carbon material in the following steps.

### <Preparation of Hard Carbon Material>

Microporous activated carbon with a pore volume of 0.35 cc/g was taken and heated to 1200° C. in an inert atmosphere being a nitrogen gas at a heating velocity of 1° C./min. Then, the inert atmosphere was replaced with a mixed gas of 5 wt % methane and an argon gas at a flow rate of 0.5 L/min. A heat preservation time t3 was 4 h. A hard carbon material was obtained.

The relevant parameters and performance tests of examples and comparative examples are shown in Table 1 and Table 2.

TABLE 1

| | | Whether | Whether | | | | Number | Number | | | | | | | | |
|---|---|---|---|---|---|---|---|---|---|---|---|---|---|---|---|---|
| | | first | second | | | | of | of | | | | | | | | |
| | Negative | charac- | charac- | | | | lithium | lithium | | | | | | | | |
| | electrode | teristic | teristic | | | | inter- | deinter- | | | | | Dᵥ | | | |
| | active | peak is | peak is | A | B − A | | calation | calation | D | V | ρ | S | 50 | X | PD | P |
| | material | present | present | (°) | (°) | I2/I1 | peaks | peaks | (μm) | (cc/g) | (g/cc) | (m²/g) | (μm) | (%) | (g/m³) | (%) |
| Example 1 | Hard | Yes | Yes | 15 | 20 | 2.9 | 4 | 4 | 0.4 | 0.01 | 1.07 | 2 | 7.1 | 0.5 | 0.92 | 38 |
| | carbon | | | | | | | | to 10 | | | | | | | |
| | material | | | | | | | | | | | | | | | |
| Example 2 | Hard | Yes | Yes | 15 | 20 | 1.4 | 4 | 4 | 0.4 | 0.02 | 1.49 | 2.5 | 7.2 | 0.5 | 1.03 | 45 |
| | carbon | | | | | | | | to 5 | | | | | | | |
| | material | | | | | | | | | | | | | | | |
| Example 3 | Hard | Yes | Yes | 15 | 20 | 0.7 | 4 | 4 | 0.4 | 0.01 | 1.74 | 2.1 | 6.9 | 0.5 | 1.07 | 36 |
| | carbon | | | | | | | | to 2 | | | | | | | |
| | material | | | | | | | | | | | | | | | |
| Example 4 | Hard | Yes | Yes | 15 | 20 | 0.3 | 4 | 4 | 0.4 | 0.01 | 1.65 | 2.4 | 7.2 | 0.5 | 1.06 | 44 |
| | carbon | | | | | | | | to 1.5 | | | | | | | |
| | material | | | | | | | | | | | | | | | |
| Example 5 | Hard | Yes | Yes | 15 | 20 | 0.3 | 4 | 4 | 0.4 | 0.01 | 1.6 | 2.3 | 7.1 | 0.5 | 1.05 | 48 |
| | carbon | | | | | | | | to 1 | | | | | | | |
| | material | | | | | | | | | | | | | | | |
| Example 6 | Hard | Yes | Yes | 15 | 20 | 0.2 | 4 | 3 | 0.4 | 0.04 | 1.57 | 2 | 7.0 | 0.5 | 1.04 | 43 |
| | carbon | | | | | | | | to 0.8 | | | | | | | |
| | material | | | | | | | | | | | | | | | |
| Example 7 | Hard | Yes | Yes | 15 | 20 | 0.1 | 4 | 4 | 0.4 | 0.02 | 1.56 | 2.3 | 7.0 | 0.5 | 1.04 | 44 |
| | carbon | | | | | | | | to | | | | | | | |
| | material | | | | | | | | 0.8 | | | | | | | |
| Example 8 | Hard | Yes | Yes | 15 | 20 | 0.4 | 4 | 4 | 0.4 | 0.01 | 1.66 | 2.4 | 7.1 | 0.1 | 1.06 | 48 |
| | carbon | | | | | | | | to | | | | | | | |
| | material | | | | | | | | 1.5 | | | | | | | |
| Example 9 | Hard | Yes | Yes | 15 | 20 | 0.3 | 4 | 4 | 0.4 | 0.01 | 1.66 | 2.4 | 7.1 | 0.3 | 1.06 | 45 |
| | carbon | | | | | | | | to | | | | | | | |
| | material | | | | | | | | 1.5 | | | | | | | |
| Example | Hard | Yes | Yes | 15 | 20 | 0.3 | 4 | 4 | 0.4 | 0.01 | 1.63 | 1.9 | 6.9 | 1.3 | 1.05 | 38 |
| 10 | carbon | | | | | | | | to | | | | | | | |
| | material | | | | | | | | 1.5 | | | | | | | |
| Example | Hard | Yes | Yes | 15 | 20 | 0.3 | 4 | 4 | 0.4 | 0.01 | 1.63 | 1.7 | 7.1 | 1.8 | 1.05 | 38 |
| 11 | carbon | | | | | | | | to | | | | | | | |
| | material | | | | | | | | 1.5 | | | | | | | |
| Example | Hard | Yes | Yes | 15 | 20 | 0.3 | 4 | 4 | 0.4 | 0.01 | 1.62 | 1.9 | 7.0 | 2 | 1.05 | 39 |
| 12 | carbon | | | | | | | | to | | | | | | | |
| | material | | | | | | | | 1.5 | | | | | | | |
| Example | Hard | Yes | Yes | 15 | 20 | 0.2 | 4 | 4 | 0.4 | 0.01 | 1.69 | 2 | 7.2 | <0.01 | 1.06 | 47 |
| 13 | carbon | | | | | | | | to | | | | | | | |
| | material | | | | | | | | 1.5 | | | | | | | |
| Example | Hard | Yes | Yes | 15 | 20 | 0.3 | 4 | 4 | 0.4 | 0.01 | 1.65 | 0.5 | 12.0 | 0.7 | 1.08 | 39 |
| 14 | carbon | | | | | | | | to | | | | | | | |
| | material | | | | | | | | 1.5 | | | | | | | |
| Example | Hard | Yes | Yes | 15 | 20 | 0.3 | 4 | 4 | 0.4 | 0.01 | 1.65 | 5 | 4.7 | 0.4 | 1.04 | 41 |
| 15 | carbon | | | | | | | | to | | | | | | | |
| | material | | | | | | | | 1.5 | | | | | | | |
| Example | Hard | Yes | Yes | 15 | 20 | 0.3 | 4 | 4 | 0.4 | 0.01 | 1.65 | 50 | 1.3 | 0.5 | 1.06 | 37 |
| 16 | carbon | | | | | | | | to | | | | | | | |
| | material | | | | | | | | 1.5 | | | | | | | |
| Com- | Artificial | / | Yes | / | / | / | 3 | 3 | <0.4 | 0.01 | 2.19 | 1.7 | 11.3 | / | 1.69 | 25 |
| parative | graphite | | | | | | | | | | | | | | | |
| example 1 | | | | | | | | | | | | | | | | |
| Com- | Hard | Yes | / | 15 | 20 | / | 1 | 1 | 0.4 | 0.08 | 2.01 | 5.6 | 7.1 | 1.3 | 1.07 | 36 |
| parative | carbon | | | | | | | | to 5 | | | | | | | |
| example 2 | material | | | | | | | | | | | | | | | |
| Com- | Hard | Yes | / | 15 | 20 | / | 1 | 1 | 0.4 | 0.02 | 1.53 | 4.2 | 7.0 | 0.2 | 0.93 | 46 |
| parative | carbon | | | | | | | | to 1.5 | | | | | | | |
| example 3 | material | | | | | | | | | | | | | | | |

Note:
“/” in Table 1 indicates that there is no relevant parameter.

TABLE 2

| | | | Energy | Capacity | | |
|---|---|---|---|---|---|---|
| | | | density | retention | Low- | High- |
| | | | ratio of | rate | temp- | temp- |
| | | First- | Com- | after | erature | erature |
| | Gram | cycle | parative | 800 | capacity | capacity |
| | capacity | efficiency | example 1 | cycles | retention | retention |
| | (mAh/g) | (%) | (%) | (%) | rate | rate |
| Example 1 | 498 | 88 | 76 | 90 | 82 | 109 |
| Example 2 | 514 | 87 | 84 | 91 | 82 | 109 |
| Example 3 | 546 | 90 | 96 | 91 | 84 | 106 |
| Example 4 | 631 | 90 | 108 | 88 | 86 | 105 |
| Example 5 | 643 | 90 | 108 | 92 | 86 | 103 |
| Example 6 | 620 | 91 | 107 | 90 | 85 | 101 |
| Example 7 | 591 | 88 | 101 | 90 | 84 | 102 |
| Example 8 | 631 | 90 | 107 | 90 | 86 | 105 |
| Example 9 | 625 | 89 | 105 | 90 | 86 | 105 |
| Example 10 | 594 | 88 | 101 | 85 | 85 | 105 |
| Example 11 | 572 | 86 | 101 | 83 | 84 | 105 |
| Example 12 | 560 | 83 | 96 | 80 | 84 | 105 |
| Example 13 | 634 | 91 | 107 | 93 | 87 | 104 |
| Example 14 | 628 | 91 | 109 | 89 | 83 | 105 |
| Example 15 | 633 | 90 | 108 | 83 | 84 | 105 |
| Example 16 | 632 | 87 | 106 | 72 | 86 | 105 |
| Com- | 360 | 95 | 100 | 87 | 74 | 101 |
| parative | | | | | | |
| example 1 | | | | | | |
| Com- | 397 | 67 | / | / | / | / |
| parative | | | | | | |
| example 2 | | | | | | |
| Com- | 584 | 74 | 83 | 82 | 82 | 106 |
| parative | | | | | | |
| example 3 | | | | | | |

Note:
“/” in Table 2 indicates that there is no relevant parameter.

It can be seen from Examples 1 to 16 and Comparative examples 1 to 3 that the X-ray diffraction pattern of the hard carbon material has the first characteristic peak and the second characteristic peak. In addition, four reversible lithium intercalation peaks and three or four reversible lithium deintercalation peaks are present within the voltage range of 0 V to 4 V in the dQ/dV curve. The values of B−A and I2/I1 are within the range of this application. The hard carbon material has a higher gram capacity and improved first-cycle efficiency compared to the hard carbon material in the comparative examples. The energy density ratio of the lithium-ion battery including the hard carbon material in this application to the lithium-ion battery in the Comparative example 1 is large, which means that the energy density of the lithium-ion battery including the hard carbon material in this application is higher and increased compared to that of the lithium-ion battery including the hard carbon material in the comparative example. Furthermore, the capacity retention rate after 800 cycles, low-temperature capacity retention rate, and high-temperature capacity retention rate of the lithium-ion battery including the hard carbon material in this application are all increased. The negative electrode active material in Comparative example 1 is artificial graphite. Although the first-cycle efficiency of artificial graphite is high, the gram capacity of artificial graphite is low. The lithium-ion battery including artificial graphite cannot ensure both high energy density and good cycling performance. This indicates that the hard carbon material in this application has higher first-cycle efficiency and can ensure both high energy density and good cycling performance. The hard carbon material in Comparative example 2 has a low gram capacity, low first-cycle efficiency, and poor performance. Therefore, the hard carbon material being used as the negative electrode active material to further prepare the lithium-ion battery for test is of little significance. Although the hard carbon material in Comparative example 3 has a high gram capacity and low first-cycle efficiency. The lithium-ion battery including artificial graphite has a low capacity retention rate after 800 cycles and cannot ensure both high energy density and good cycling performance.

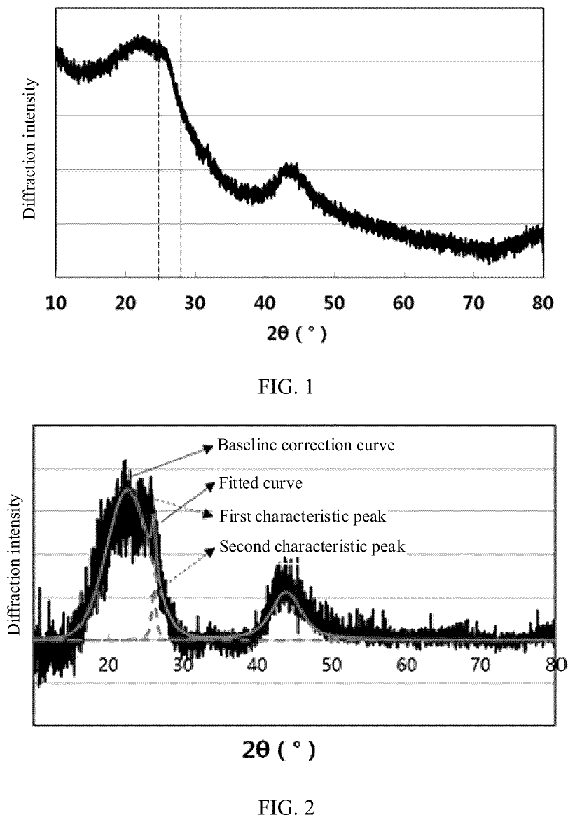

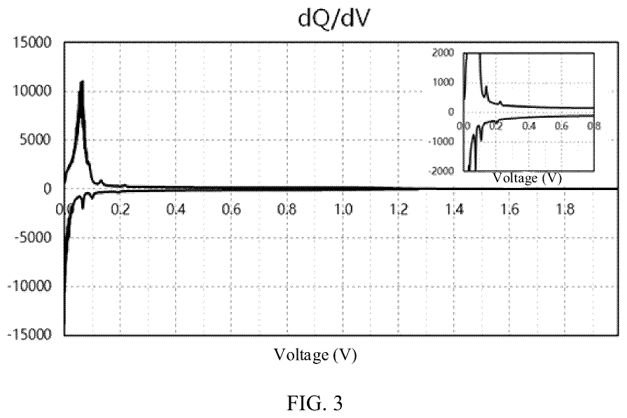

FIG. 1 is an XRD pattern of Example 4. The XRD pattern of Example 4 has the first characteristic peak and the second characteristic peak. To more clearly determine the peak positions of the first characteristic peak and the second characteristic peak, FIG. 2 shows an XRD peak separation pattern after baseline correction of FIG. 1. It can be seen from FIG. 2 that the first characteristic peak is located between 15° and 35°, and the second characteristic peak is located between 25° and 28°. FIG. 3 is a differential capacity curve of Example 4. Further, for ease of observation, the upper right corner of FIG. 3 is a locally enlarged view of the original differential capacity curve. It can be seen from FIG. 3 that the negative electrode plate in Example 4 has four reversible lithium intercalation peaks and four reversible lithium deintercalation peaks within the voltage range of 0 V to 0.4 V. This indicates that the hard carbon material in Example 4 has a locally ordered graphitization structure.

The maximum inscribed circle diameter D of the pores in the internal pore structure of the hard carbon material usually affects the energy density and cycling performance of the lithium-ion battery. It can be seen from Examples 1 to 7 that when the maximum inscribed circle diameter D of the pores in the internal pore structure of the hard carbon material is within the range of this application, the hard carbon material has high gram capacity and first-cycle efficiency. The obtained lithium-ion battery has a high energy density while and a high capacity retention rate after 800 cycles, low-temperature capacity retention rate, and high-temperature capacity retention rate. This indicates that the lithium-ion battery provided in this application has a high energy density and good cycling performance.

The pore volume V of the external pore structure of the hard carbon material usually affects the energy density and cycling performance of the lithium-ion battery. It can be seen from Examples 1 to 16 that when the pore volume V of the external pore structure of the hard carbon material is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

The porosity P of the hard carbon material usually affects the energy density and cycling performance of the lithium-ion battery. It can be seen from Examples 1 to 16 that when the porosity P of the hard carbon material is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

The true density ρ of the hard carbon material usually affects the energy density and cycling performance of the lithium-ion battery. It can be seen from Examples 1 to 16 that when the true density ρ of the hard carbon material is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

The specific surface area S of the hard carbon material usually affects the energy density and cycling performance of the lithium-ion battery. It can be seen from Examples 1 to 16 that when the specific surface area S of the hard carbon material is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

Dᵥ50 of the hard carbon material usually affects the energy density and cycling performance of the lithium-ion battery. It can be seen from Examples 1 to 16 that when Dᵥ50 of the hard carbon material is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

The mass percentage X of the heteroelement in the hard carbon material usually affects the energy density and cycling performance of the lithium-ion battery. It can be seen from Example 4 and Examples 8 to 13 that when the mass percentage X of the heteroelement in the hard carbon material is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

The compacted density PD of the negative electrode active material layer usually affects the energy density and cycling performance of the lithium-ion battery. It can be seen from Examples 1 to 16 that when the compacted density PD of the negative electrode active material layer is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

The porosity P of the negative electrode active material layer usually affects the energy density and cycling performance of the lithium-ion battery. It can be seen from Examples 1 to 16 that when the porosity P of the negative electrode active material layer is within the range of this application, the hard carbon material has a high gram capacity and first-cycle efficiency. The obtained lithium-ion battery has a high energy density and a high capacity retention rate after 800 cycles, low-temperature capacity retention rate, and high-temperature capacity retention rate. This indicates that the lithium-ion battery provided in this application has a high energy density and good cycling performance.

It should be noted that in this specification, the relational terms such as “first” and “second” are only used to distinguish one entity or operation from another entity or operation, and do not necessarily require or imply any such actual relationship or order between these entities or operations. In addition, the terms “comprise”, “include”, or any other variations thereof are intended to cover a non-exclusive inclusion, so that a process, a method, or an item including a series of elements not only includes those elements but also includes other elements that are not expressly listed, or further includes elements inherent to such process, method, or item.

Various embodiments in this specification are described in related manners, provided that same or similar parts of various embodiments are referred to each other. Each embodiment focuses on the difference from another embodiment.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A hard carbon material, wherein an X-ray diffraction pattern of the hard carbon material has a first characteristic peak from 150 to 350 and a second characteristic peak from 25° to 28°; a starting position of the first characteristic peak is A°, an ending position of the first characteristic peak is B°, and B−A≥8°; a peak intensity of the first characteristic peak is I1, a peak intensity of the second characteristic peak is 12, and 0.1≤I2/I1≤3.0; and
wherein when an electrode plate prepared using the hard carbon material as an active material is subjected to charge and discharge test with lithium metal as a counter electrode to obtain a differential capacity curve, the electrode plate has four reversible lithium intercalation peaks and three or four reversible lithium deintercalation peaks within a voltage range of 0 V to 0.4 V.

2. The hard carbon material according to claim 1, wherein the hard carbon material has an internal pore structure, and a maximum inscribed circle diameter of pores in the internal pore structure is 0.40 nm to 10 nm.

3. The hard carbon material according to claim 2, wherein the hard carbon material satisfies one of the following characteristics:
(1) the maximum inscribed circle diameter of the pores in the internal pore structure is 0.40 nm to 2 nm; or
(2) the maximum inscribed circle diameter of the pores in the internal pore structure is 0.40 nm to 0.80 nm.

4. The hard carbon material according to claim 1, wherein a surface of the hard carbon material has an external pore structure, and a pore volume of the external pore structure obtained by adsorption test is less than or equal to 0.05 cc/g.

5. The hard carbon material according to claim 1, wherein a true density of the hard carbon material is 0.9 g/cc to 2.0 g/cc.

6. The hard carbon material according to claim 1, wherein the hard carbon material satisfies at least one of the following characteristics:
(1) a specific surface area of the hard carbon material is 0.5 m²/g to 50 m²/g; or
(2) Dᵥ50 of the hard carbon material is 3 μm to 12 μm.

7. The hard carbon material according to claim 6, wherein the hard carbon material satisfies at least one of the following characteristics:
(1) the specific surface area of the hard carbon material is 0.5 m²/g to 5 m²/g; or
(2) Dᵥ50 of the hard carbon material is 5 μm to 9 μm.

8. The hard carbon material according to claim 1, wherein the hard carbon material comprises a heteroelement; wherein the heteroelement comprises at least one of Li, Na, K, Cs, Mg, Al, Ca, Rb, Zn, Fe, Ni, Co, N, O, H, P, S, B, or Se; and based on a mass of the hard carbon material, a mass percentage of the heteroelement is greater than 0 and less than or equal to 3%.

9. A preparation method of the hard carbon material as claimed in claim 1, the preparation method comprising following steps:
(1) well mixing a reactant, a catalyst, and a solvent to obtain a reaction solution, and drying the reaction solution to obtain a precursor;
wherein a mass ratio of the catalyst to the reactant is 0.01 to 1; the reactant comprises at least one of novolac resin, furfural resin, epoxy resin, asphalt, starch, glucose, sucrose, or fructose; the solvent comprises at least one of ionized water, ethanol, benzene, toluene, or N-methylpyrrolidone; and the catalyst comprises at least one of lithium hydroxide, sodium hydroxide, potassium hydroxide, magnesium hydroxide, cesium hydroxide, rubidium hydroxide, calcium hydroxide, aluminum hydroxide, alumina, aluminum oxide, zinc oxide, zinc chloride, iron, triiron tetraoxide, ferric chloride, ferric oxide, nickel oxide, nickel sulfate, nickel hydroxide, nickel chloride, cobalt nitrate, cobalt oxide, urea, phosphoric acid, lignin, boric acid, sodium selenate, sodium benzoate, potassium benzoate, or sodium cinnamate;
(2) performing acid washing after a first carbonization treatment on the precursor in an inert atmosphere, and then performing a second carbonization treatment in the inert atmosphere to obtain a carbonization product;
wherein a temperature T1 of the first carbonization treatment is 500° C. to 900° C., a time t1 of the first carbonization treatment is 0.5 h to 5 h, and a heating velocity v1 of the first carbonization treatment is 0.5° C./min to 10° C./min; and a temperature T2 of the second carbonization treatment is 1000° C. to 1600° C., a time t2 of the second carbonization treatment is 0.5 h to 15 h, and a heating velocity v2 of the second carbonization treatment is 0.5° C./min to 10° C./min; and
(3) heating the carbonization product to 500° C. to 1100° C. in the inert atmosphere at a heating velocity of 0.5° C./min to 20° C./min, and then performing a heat preservation treatment in a reducing atmosphere to obtain the hard carbon material;
wherein the inert atmosphere comprises at least one of a nitrogen gas, an argon gas, or a helium gas; a time t3 of the heat preservation treatment is 0.1 h to 8 h; and the reducing atmosphere comprises at least one of the argon gas, acetylene, or methane.

10. A secondary battery, comprising a positive electrode plate, a negative electrode plate and an electrolyte; the negative electrode plate comprising a negative electrode current collector and a negative electrode active material layer disposed on at least one surface of the negative electrode current collector; wherein the negative electrode active material layer comprises the hard carbon material as claimed in claim 1.

11. The secondary battery according to claim 10, wherein a compacted density of the negative electrode active material layer is 0.7 g/cm³ to 1.7 g/cm³.

12. The secondary battery according to claim 10, wherein a porosity of the negative electrode active material layer is 10% to 50%.

13. The secondary battery according to claim 10, wherein the hard carbon material has an internal pore structure, and a maximum inscribed circle diameter of pores in the internal pore structure is 0.40 nm to 10 nm.

14. The secondary battery according to claim 13, wherein the maximum inscribed circle diameter of the pores in the internal pore structure is 0.40 nm to 2 nm.

15. The secondary battery according to claim 14, wherein the maximum inscribed circle diameter of the pores in the internal pore structure is 0.40 nm to 0.80 nm.

16. The secondary battery according to claim 10, wherein a surface of the hard carbon material has an external pore structure, and a pore volume of the external pore structure obtained by adsorption test is less than or equal to 0.05 cc/g.

17. The secondary battery according to claim 10, wherein a true density of the hard carbon material is 0.9 g/cc to 2.0 g/cc.

18. The secondary battery according to claim 10, wherein the hard carbon material comprises a heteroelement, wherein the heteroelement comprises at least one of Li, Na, K, Cs, Mg, Al, Ca, Rb, Zn, Fe, Ni, Co, N, O, H, P, S, B, or Se, and based on a mass of the hard carbon material, a mass percentage of the heteroelement is greater than 0 and less than or equal to 3%.

19. The secondary battery according to claim 10, wherein the hard carbon material satisfies at least one of the following characteristics:
(1) a specific surface area of the hard carbon material is 0.5 m²/g to 50 m²/g; or
(2) Dᵥ50 of the hard carbon material is 3 μm to 12 μm.

20. The secondary battery according to claim 19, wherein the hard carbon material satisfies at least one of the following characteristics:
(1) the specific surface area of the hard carbon material is 0.5 m²/g to 5 m²/g; or
(2) Dᵥ50 of the hard carbon material is 5 μm to 9 μm.
